(19) United States
(12) Patent Application Publication
(10) Pub. No.: US 2011/0040962 A1
(43) Pub. Date: Feb. 17, 2011

(54) METHOD OF SETTING THE SOUND VOLUME OF AN ELECTRONIC DEVICE

(76) Inventor: Jean-Francois Peyre, Rousset (FR)

Correspondence Address: SUGHRUE MION, PLLC, 2100 PENNSYLVANIA AVENUE, N.W., SUITE 800, WASHINGTON, DC, 20037, US

(21) Appl. No.: 12/934,071

(22) PCT Filed: Mar. 24, 2009
(86) PCT No.: PCT/FR09/00316

§ 371 Date: Oct. 27, 2010

(30) Foreign Application Priority Data
Mar. 26, 2008 (FR) 0801644

(51) Int. Cl. G06F 9/24; G01C 9/00

(52) U.S. Cl. 713/100; 702/154

(57) ABSTRACT

The present invention relates to an electronic device comprising a microphone, a loudspeaker, and a ringer, the device also comprising at least one inclination detector used for setting sound volume, the volume setting having at least two ranges, a first range (1) with a loud volume setting corresponding to circumstances in which the device is positioned horizontally and face-up, enabling it to operate in a hands-free mode, and a second range (2) with the volume set to low volume that is activated when the device departs from said horizontal position so as to operate in listener mode. Furthermore, the volume setting includes a third range defining a silent mode when the device is positioned horizontally and face-down.

The present invention relates to a method of setting the sound volume of an electronic device by using a detector of the accelerometer type.

The system is particularly adapted to a wireless or mobile telephone terminal. Nowadays such terminals incorporate more and more functions, and the ease of use provided by the present invention is most advantageous thereto.

Accelerometers, measuring relative to two or three axes, are commonly used in modern mobile telephones for functions such as orienting the display, rotation, selecting “portrait” mode or “landscape” mode, navigating amongst menus by tapping correcting the fuzziness of digital images generated by vibration and movement, detecting a fall or theft, detecting the absence of movement in order to select low power consumption mode.

Nowadays accelerometers are also used for setting sound volume during a conversation. Thus, documents WO 00/57616 and EP 1 748 631 both describe devices that include an inclination detector to set sound volume. The volume setting has at least two ranges, a first range in which volume is set to a maximum corresponding to the device being positioned horizontally while facing upwards, enabling it to operate in “hands-free” mode, and a second range with a lower volume setting that is activated as soon as the device departs from the horizontal position, so as to operate in “listener” mode.

Nevertheless, certain circumstances appear in which it is desirable temporarily to interrupt telephone conversation while maintaining communication.

The present invention thus seeks to provide this additional characteristic.

According to the invention, an electronic device comprises a microphone, a loudspeaker, and a ringer, and also comprises at least one inclination detector used for setting sound volume, the volume setting having at least two ranges, a first range with a loud volume setting corresponding to circumstances in which the device is positioned horizontally and face-up, enabling it to operate in a hands-free mode, and a second range with the volume set to low volume that is activated when the device departs from said horizontal position so as to operate in listener mode, in addition, the volume setting includes a third range defining a silent mode when the device is positioned horizontally and face-down.

This provides a setting mode that is very easy and very intuitive, particularly adapted to simplifying the use of an electronic device and in particular of a mobile telephone.

Advantageously, the microphone and/or the loudspeaker and/or the ringer is deactivated in silent mode.

In a preferred embodiment, the inclination detector consists in one or more micro-machined accelerometers for detecting inclination relative to one, two, or three orthogonal axes, a longitudinal axis (X) and a transverse axis (Z).

Preferably, the inclination is averaged over a plurality of successive samples in order to be unaffected by measurement variations induced by vibration and movement of the device.

It is desirable for hands-free mode operation to be authorized only if the inclination relative to the horizontal relative to the lateral axis (Y) is less than a predefined value.

Optionally, the volume setting may be stored by applying a command so that the setting is conserved during subsequent movement of the device and until the memory function is released.

According to an additional characteristic of the invention, the hands-free mode is activated only if the variations in the inclination remain within predefined limits.

In addition, the hands-free mode is activated progressively, whereas listener mode is activated immediately so as to avoid untimely switching to loud volume while in movement.

Furthermore, if the device is in the form of a casing having at least two portions that are hinged together, the inclination detector being attached to a first portion of the casing, the device advantageously includes an additional detector attached to the second portion of the device to adjust the volume as a function of the angle made between the two portions.

The invention can be better understood, and other objects, advantages, and characteristics thereof appear more clearly on reading the following description of preferred embodiments given by way of non-limiting example and with reference to an accompanying sheet of drawings, in which:

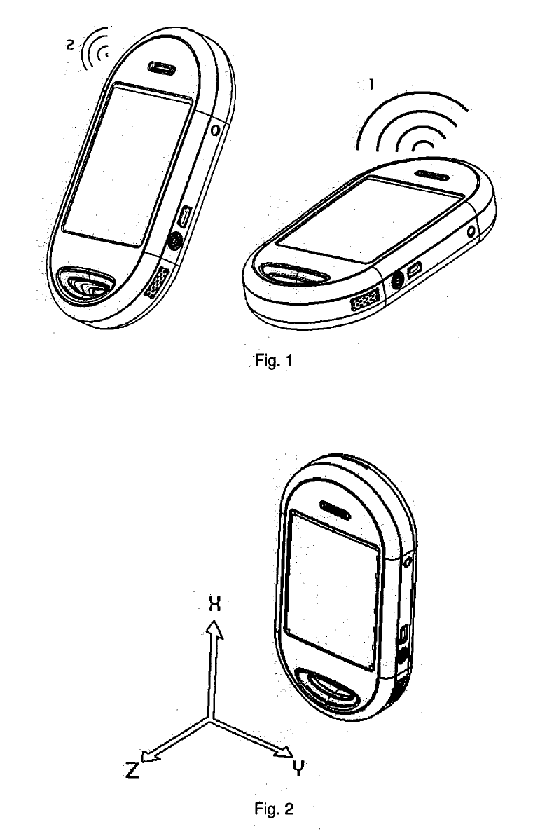

FIG. 1 shows a non-limiting example showing two modes of operation, a hands-free mode corresponding to the situation in which the device is close to the horizontal and facing upwards, and a listening mode in which the device has departed from the horizontal; and

FIG. 2 is a diagram showing the three axes (X, Y, Z) that may be used in non-limiting manner for defining the position of the device in three dimensions.

As shown in FIG. 2, use is made mainly of measurement along the transverse axis (Z) for defining whether the device is horizontal, however it is advantageous also to make use of the other two axes (X, Y) for refining the mode that is set.

The face-up horizontal position corresponds to an extremum of measurement relative to the axis (Z), a minimum or a maximum depending on the orientation of the detector, with the absolute value of the measured acceleration then being substantially equal to gravity. A simple test for said value for comparison with a predefined threshold thus serves to activate or not activate the loud-volume mode referred to as “hands-free” mode.

However, acceleration along the axis (Y) may also be used to authorize hands-free mode when the device is inclined away from the horizontal, head-down, since such a position corresponds to a measurement along the axis (Z) that is identical to the normal vertical mode that ought to correspond to a low-volume mode referred to as “listener” mode.

Furthermore, acceleration along the axis (X) may be used for improving validation of the horizontal configuration and avoiding false detection due to the device moving.

The present invention thus proposes an electronic device making use of at least one inclination detector for setting the sound volume delivered.

In non-limiting manner, inclination is detected by one or more micro-machined accelerometers that detect inclination relative to one, two, or three orthogonal axes, a longitudinal axis (X), a lateral axis (Y), and a transverse axis (Z).

In a preferred embodiment, the inclination measurements are averaged over a plurality of successive samples, e.g. by the moving average technique, so as to be unaffected by measurement variations induced by the device vibrating and moving.

Advantageously, the volume setting has three ranges, a first range (1) set to a loud volume (possibly a maximum volume), corresponding to when the device is positioned horizontally facing upwards, suitable for operating in hands-free mode, a second range (2) with volume being set to a lower level, which range is activated as soon as the device departs from the horizontal position, so as to operate in listener mode, and a third range defining a silent mode, e.g. when the device is positioned horizontally and facing downwards.

The present invention may be applied to a telephone terminal in which the inclination detector sets, independently, the sound volume(s) of the loudspeaker(s) and of the ringer, e.g. with the volume of the ringer being set to zero when the terminal is placed face down.

Such a telephone terminal may advantageously use the inclination detector to define a range in which the microphone is deactivated, e.g. in silent mode during a conversation.

In any device in accordance with the present invention, loud-volume operation may be activated essentially by measuring acceleration along the transverse axis (Z).

In a particular embodiment, loud-volume operation is authorized only if the inclination relative to the horizontal along the lateral axis (Y) is less than said predefined value, e.g. 15 degrees.

In non-limiting manner, the volume setting defined by the detector may be stored by applying a mechanical, voice, or other command, so as to conserve said volume setting during subsequent movements of the device and until the memory function is released.

In a preferred embodiment, loud-volume operation is authorized only when it is detected that the terminal is at rest by observing that the accelerations measured by the accelerometer vary below predefined limits, e.g. less than 5 percent for 2 seconds.

Advantageously, loud-volume mode is activated progressively after a delay or a rise time of a few seconds, whereas low-volume mode is activated immediately so as to avoid switching in untimely manner to loud volume while in motion.

In a preferred embodiment of the present invention, the casing of the device comprises at least two portions that are hinged together. A first inclination detector attached to a first portion of the casing, e.g. the bottom portion, serves to switch to hands-free mode when said portion is detected as being close to horizontal, whereas a second inclination detector, e.g. an accelerometer having a single detection axis and attached to the second portion serves to adjust said volume more finely, e.g. as a function of the angle to which the hinge connecting the two portions together is opened.

The positioning of the various component elements gives the subject matter of the invention a maximum amount of useful effects that, in the past, have not been obtained while using similar devices.

1. An electronic device comprising a microphone, a loudspeaker, and a ringer, the device also comprising at least one inclination detector used for setting sound volume, the volume setting having at least two ranges, a first range (1) with a loud volume setting corresponding to circumstances in which the device is positioned horizontally and face-up, enabling it to operate in a hands-free mode, and a second range (2) with the volume set to low volume that is activated when the device departs from said horizontal position so as to operate in listener mode, the device being characterized in that the volume setting includes a third range defining a silent mode when the device is positioned horizontally and face-down.

2. A device according to claim 1, characterized in that said microphone is deactivated in said silent mode.

3. A device according to claim 1, characterized in that said loudspeaker is deactivated in said silent mode.

4. A device according to claim 1, characterized in that said ringer is deactivated in said silent mode.

5. A device according to claim 1, characterized in that said inclination detector consists in one or more micro-machined accelerometers for detecting inclination relative to one, two, or three orthogonal axes, a longitudinal axis (X) and a transverse axis (Z).

6. A device according to claim 1, characterized in that said inclination is averaged over a plurality of successive samples in order to be unaffected by measurement variations induced by vibrations and movement of the device.

7. A device according to claim 1, characterized in that hands-free mode operation is authorized only if the inclination relative to the horizontal relative to the lateral axis (Y) is less than a predefined value.

8. A device according to claim 1, characterized in that the volume setting may be stored by applying a command so that said setting is conserved during subsequent movement of the device and until said memory function is released.

9. A device according to claim 1, characterized in that said hands-free mode is activated only if the variations in said inclination remain within predefined limits.

10. A device according to claim 1, characterized in that said hands-free mode is activated progressively, whereas listener mode is activated immediately so as to avoid untimely switching to loud volume while in movement.

11. A device according to claim 1, characterized in that the device is in the form of a casing having at least two portions that are hinged together, with said inclination detector being attached to a first portion of the casing, and the device including an additional detector attached to the second portion in order to adjust said volume as a function of the angle formed between the two portions.
